(19) United States
(12) Patent Application Publication
(10) Pub. No.: US 2015/0050146 A1
(43) Pub. Date: Feb. 19, 2015

(54) Rotor Blade for a Water Turbine, in Particular for a Tidal Power Station, and Method for Operating Same

(71) Applicants: Harald Dorweiler, Schifferstadt (DE); Norman Perner, Neu-Ulm (DE); Frank Biskup, Schwabisch Gmund (DE)

(72) Inventors: Harald Dorweiler, Schifferstadt (DE); Norman Perner, Neu-Ulm (DE); Frank Biskup, Schwabisch Gmund (DE)

(21) Appl. No.: 14/353,386

(22) PCT Filed: Aug. 11, 2012
(86) PCT No.: PCT/EP2012/003445

§ 371 Date: Jul. 15, 2014

(30) Foreign Application Priority Data
Oct. 28, 2011 (DE) 10 2011 117 176.6

(51) Int. Cl. F03B 3/12; F03B 11/00; F03B 13/26; F03B 3/14

(52) U.S. Cl. CPC F03B 3/123; F03B 3/145; F03B 11/004; F03B 13/26
USPC 416/1; 415/3.1; 416/223 R; 416/197 A

(57) ABSTRACT

The invention concerns a rotor blade for a water turbine with a hydrodynamic profile, to which a suction side and a pressure side are associated, comprising a plurality of overflow channels, which are arranged in the hydrodynamic profile and create a hydraulic connection between the suction side and the pressure side and to which a valve arrangement is associated respectively.

The invention is characterised in that the valve arrangement is closed below a preset load limit threshold for the rotor blade and is opened above the load limit threshold, whereas every overflow channel with the valve arrangement in the open position reduces the power coefficient and/or the thrust coefficient of the rotor blade with respect to the closed position.

The invention concerns a rotor blade for a water turbine, in particular for a tidal power plant or a river water power station, and a method for operating the same.

Water turbines surrounded by free flows for generating energy from a water current, in particular tidal or ocean current, are known. Such plants can be used in rivers also for generating energy whereas extensive water-structural measures for erecting dam structures can be dispensed with. We may be dealing here with plants with foundations, for which a gondola is supported against the water bed via a tower. Alternatively, the plant is fitted with a buoyancy in such a way that the latter is floatable, whereas in such a case an anchoring system holds the gondola with the water turbine in the operating position. A possible form of construction of generic plants include rotor-shaped water turbines wherein the rotors are horizontal. Rotors with rotor blades directed radially and outwardly or with rotor blades directed radially and inwardly starting from a support ring may be envisioned

The plant must be adapted for a cyclic exchange of the inflow direction for generating energy from tidal movements. If any blade angle moving mechanism or any rotary device for tracking the whole water turbine around the vertical axis of the plant is done away with, the rotor blades must be provided with a bidirectional profile facing the incoming flow. For that purpose, lenticular blade cross-sections or profiles with an S-shaped stroke are known. To improve the degree of hydraulic efficiency of such profiles, DE 10 2009 057 449 B3 discloses overflow channels which can switch between the pressure side and the suction side of the profile. These enable to mitigate the effect of the respective portion of profile on the downstream side. Moreover, WO 2009 143846 A1 and U.S. Pat. No. 1,553,627 A describe continuous-flow machines with slotted rotors, which increase the degree of efficiency by transferring and accelerating a partial flow from the pressure side to the suction side. Moreover, overflow channels are known which circulate from the pressure side to the suction side of the profile, to trigger the boundary layer through a dosed fluid outlet and to avoid a flow separation. To do so, it may be referred to DE 5 35 504 A and DE 1187559 A by way of example.

Generic plants without dam structures are difficult to maintain due to the expensive recovery. This is particularly true on a maritime site so that a critical requirement consists in using the heaviest-duty design as far as possible. Plants exhibiting systems which are as little accident-prone as possible are therefore preferred. The result is a low-maintenance concept without a blade angle moving mechanism or a device for rotating the whole plant about the vertical axis. The shortcoming of said arrangement is however that the water turbine must be designed in such a way that it resists a peak load occurring in exceptional cases. A known measure for reducing the load with a strong inflow consists in a plant operation in fast run mode, which reduces the degree of hydraulic efficiency and the thrust loads on the rotor blades. Indeed, the load on the rotor blades cannot be reduced further when the runaway speed has been reached so that a highly expensive construction is necessary to achieve a reliable layout of the water turbine. Moreover, rotor blades are used for safety reasons for the simplified plant design with rotationally rigidly hinged rotor blades and without a mechanism for pivoting the plant, rotor blades which are too small for an efficient operation under normal conditions.

The object of the invention is then to provide a rotor blade for a water turbine and an operating method carried therewith, which resists strong load peaks. To do so, the rotor blade should exhibit a high degree of efficiency for the incoming flow occurring under normal operating conditions. Moreover, the rotor blade should be appropriate for water turbines surrounded by free flows and in particular the generation of energy from a bidirectional incoming flow.

The object of the invention is hence satisfied by the characteristics of the independent claims. Advantageous embodiments are divulged in the depending claims.

A rotor blade according to the invention exhibits at least several overflow channels over a partial section of the blade extension, channels which create a hydraulic connection between the suction side and the pressure side of the profile. At least one valve arrangement is associated with the overflow channels, a valve arrangement which is designed in such a way that it is closed below a preset load limit threshold and is opened above the load limit threshold. The load limit threshold is preferably defined by a preset rotational speed of the water turbine. Additional preferred embodiments define the load limit threshold using a preset dynamic pressure conditioned by the incoming flow at the water turbine or a preset differential pressure between the suction side and the pressure side of the profile. A valve arrangement can thereby be used which functions passively and closes automatically once the load limit threshold has been reached. In an alternative execution, the moment when the load limit threshold has been reached is detected by a control apparatus which processes data, such as the incoming flow velocity, the rotor rotational speed or the loads imposed on the retaining structures of the plant, whereas the control apparatus sends corrective signals to the valve arrangement.

The overflow channels with the associated valve arrangement act as an overload protection system. Under those circumstances, said channels are disposed in such a way that an open overflow channel reduces the power coefficient and/or the thrust coefficient of the rotor blade. Consequently, the overflow channels, as regards their number density and their cross-section, are arranged in such a way that the differential pressure is sufficiently reduced between the suction side and the pressure side and the efficiency of the profile section with the overflow channels in the case of an open valve arrangement is reduced in such a way that the load of the rotor blade decreases. This leads to the necessity of being able to guide a sufficient flow volume through the overflow channels which not only avoids any boundary layer excitation but also enables to reduce the buoyancy in the profile section with the overload protection drastically. A further preferred measure for effectively reducing the power coefficients and/or the thrust coefficients consists in laying out the overflow channels in such a way that the inflow and the outflow of the profiled surrounding flow counteract. For this purpose, the overflow channels are preferably designed in such a way that they are arranged obliquely with respect to the vertical to the centre line so that the inflow into the overflow channels on the pressure side as well as the outflow on the suction side exhibit a direction component opposite to the profile flow. Moreover, parts of the valve arrangement in the open position can modify the profile outline in such a way that the degree of hydraulic efficiency decreases. A rotor blade according to the invention to the medium load area can be configured and then be allocated a greater size with respect to a rotor blade without overload protection. The result is a substantial increase in the degree of efficiency of the whole plant for an operation under normal incoming flow conditions.

In a preferred embodiment, the overload protection with the overflow channels that opened in case of overload is only available with a limited partial region of the profile whereas an arrangement in a region close to the blade tip is advantageous. It is then preferable to locate the overflow channels on a surface which is smaller than a third of the whole surface of the rotor blade.

In a particularly preferred embodiment, the overload protection functions passively. Subsequently, the valve arrangement switches once the load limit threshold has been reached due to the loads applied to the plant without a separate control device being necessary. In a preferred embodiment, the valve arrangement contains a membrane which is provided on the suction side of the profile for covering at least one overflow channel. The membrane has at least one membrane opening which is offset to an inlet and/or outlet opening of the associated overflow channel. When the membrane lifts from the inlet opening and/or the outlet opening of the associated overflow channel, a hydraulic connection appears between the pressure side and the suction side of the profile. The opening of the valve arrangement against the tension of the membrane can be triggered passively by a differential pressure between the pressure side and the suction side of the profile which is large enough in case of overload. In a further embodiment to obtain an active system, a support cylinder mounted behind the membrane can be used, which, when in the deployed position, lifts the membrane from the respective inlet and/or outlet opening of the overflow channel. Such a support cylinder can be designed as an electrically operated unit. To do so, a device with a solenoid spool in particular can be considered. In the active configuration with an actuating element, the membrane can be mounted on the suction side and/or on the pressure side of the rotor blade profile. Moreover, the membrane should be selected for this execution in such a way that it resists the punctual load through the adjustment element. Forms of embodiments can therefore be envisioned which at least in the loaded areas receive a sheet metal or an armoured synthetic plate or are composed of these materials over their whole surface. Moreover, an element forming sliding surfaces, such as a PTFE film, can be mounted on the support point of the support cylinder on the membrane.

In an alternative embodiment, an actively switched valve arrangement and an associated control device can be provided to determine the load limit threshold. A central valve arrangement is therefore provided for several overflow channels. In a preferred embodiment, the overflow channels so bundled up on the pressure side of the profile lead to a pressure-side collection chamber. Under those circumstances, a suction-side collection chamber rests on the suction side of the profile, a collection chamber into which the suction-side partial sections of the overflow channels emerge. There is a connection via a central valve arrangement between the pressure-side collection chamber and the suction-side collection chamber. A configuration can be envisioned for which respectively the overflow channels are grouped per area and can be connected via an associated central valve arrangement. To do so, it is also possible to use a plurality of central valve arrangements.

The valve arrangement for releasing or for blocking an overflow channel can be actuated electrically or hydraulically to achieve an active configuration. In the case of an electrical adjusting element, the generation of energy unfolds preferably via an inductive system, working contactless to transfer the power in the region of the rotor hub. In a hydraulic configuration, a pressure medium can be provided in the passage between the stationary part of the plant and the rotor by means of an annular channel. A configuration, for which the hydraulic pressure used for the operation of the adjustment device comes from an energy generation device arranged in the region of the rotating unit of the water turbine, can be envisioned. In an alternative embodiment, the dynamic pressure acting upon a portion of the plant can be used for operating the adjusting elements of the valve arrangement.

In a further, preferred embodiment, at least one valve arrangement with a control slide valve is used, which carries out adjusting movements which are mostly directed to the longitudinal axis of the blades. To do so, the control slide valve can be guided into the open position to oppose the force effect of an elastic adjusting element. For such a configuration, the centrifugal force effect progressing with an increasing rotor rotational speed results in moving the control slide valve against the elastic element until the valve arrangement opens. Accordingly, the preset load limit threshold is defined by a limit for the rotational speed for which the overload protection is triggered.

The invention is described below using exemplary embodiments in combination with figure representations, wherein the following elements are illustrated:

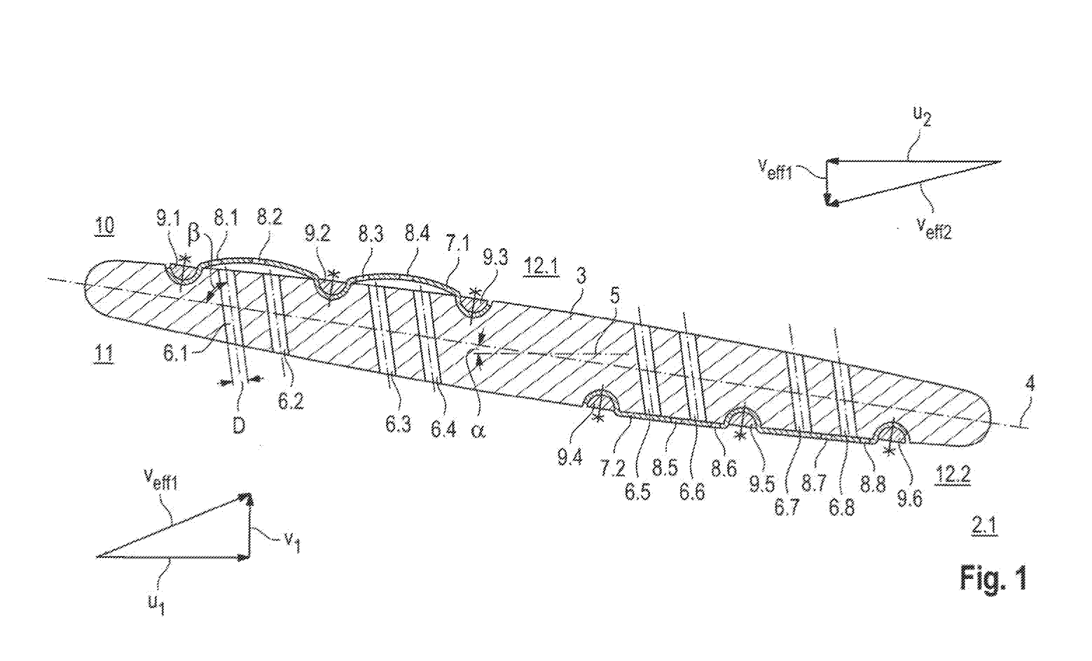

FIG. 1 shows a profile section for a rotor blade according to the invention with an overload protection system which includes a plurality of overflow channels with an associated valve arrangement.

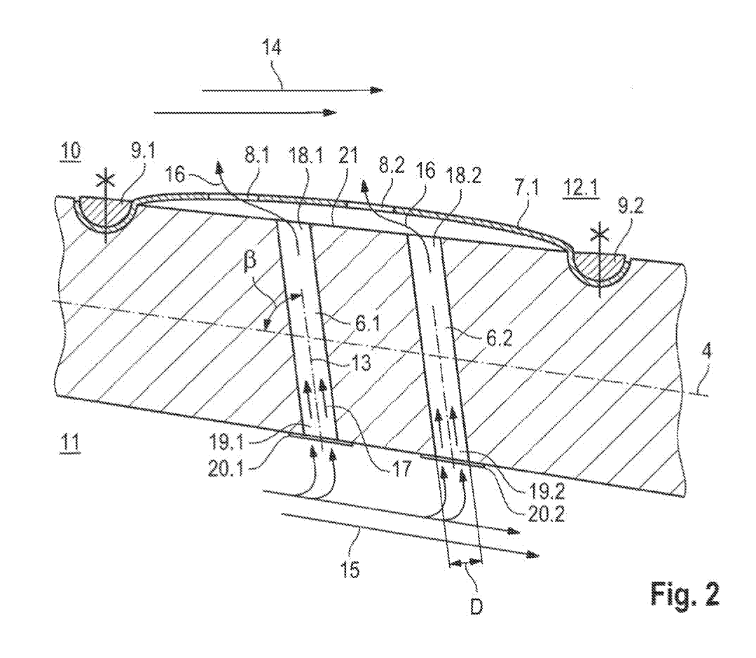

FIG. 2 represents a partial cut-out of the profile of FIG. 1, whereas the overload protection system includes a valve arrangement with a membrane stretched through the overflow channels.

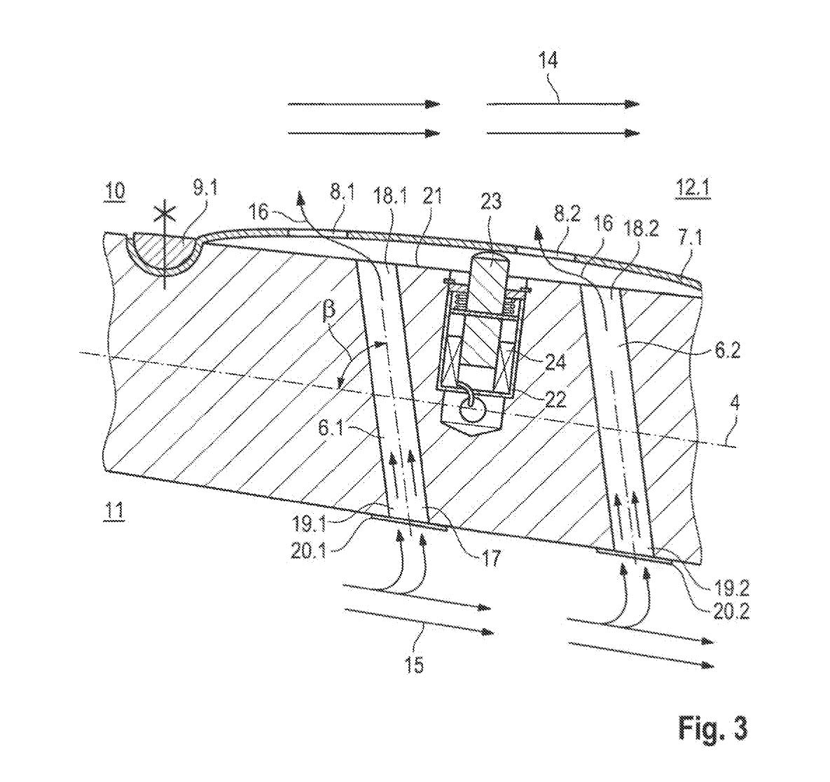

FIG. 3 represents a further embodiment of the execution according to FIG. 2 whereas the membrane can be lifted by means of a support cylinder.

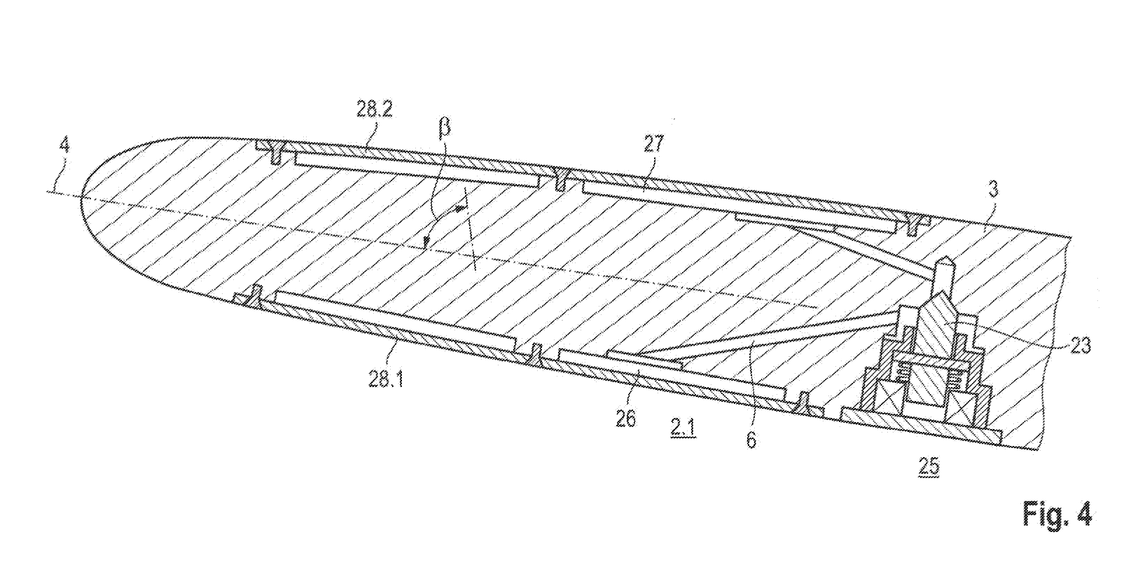

FIG. 4 shows an alternative embodiment using a profile section of a partial area of a rotor blade according to the invention with a pressure-side collection chamber and a suction-side collection chamber and an interconnected central valve arrangement.

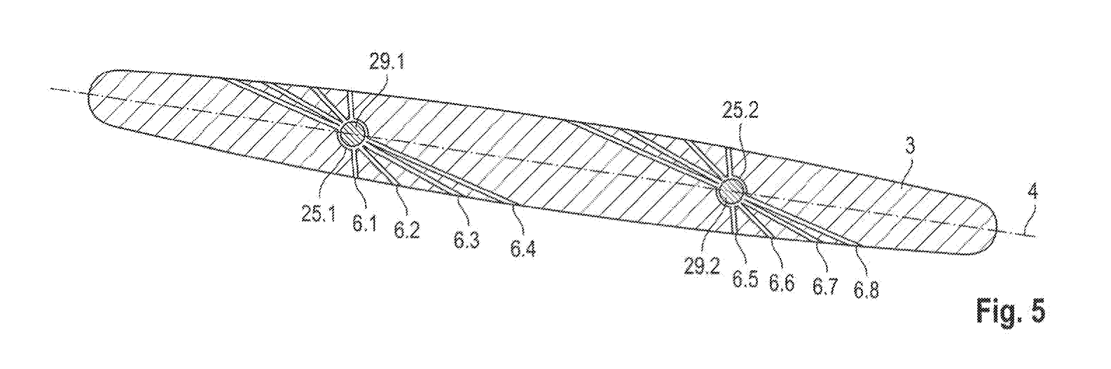

FIG. 5 shows an alternative embodiment with a valve arrangement which bundles up a plurality of overflow channels and to which a control slide valve arranged in the longitudinal direction of the blades is associated.

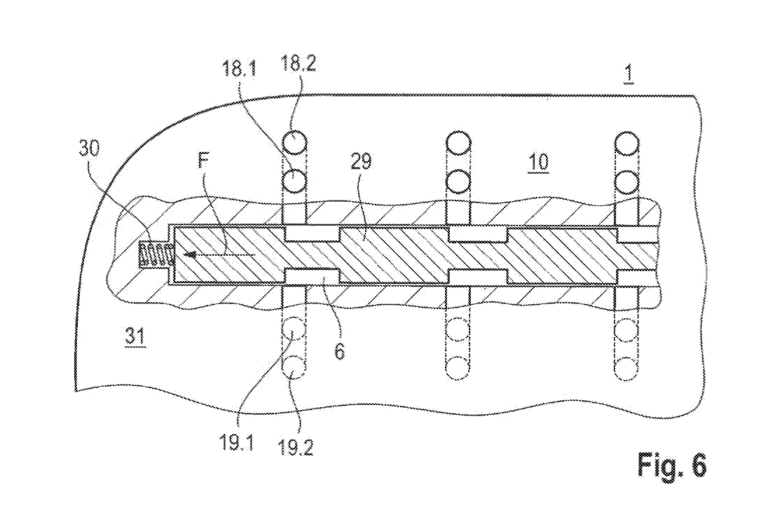

FIG. 6 shows in a partial sectional view of the rotor blade a control slide valve arranged in the longitudinal direction of the blades for the valve arrangement of the overflow channels.

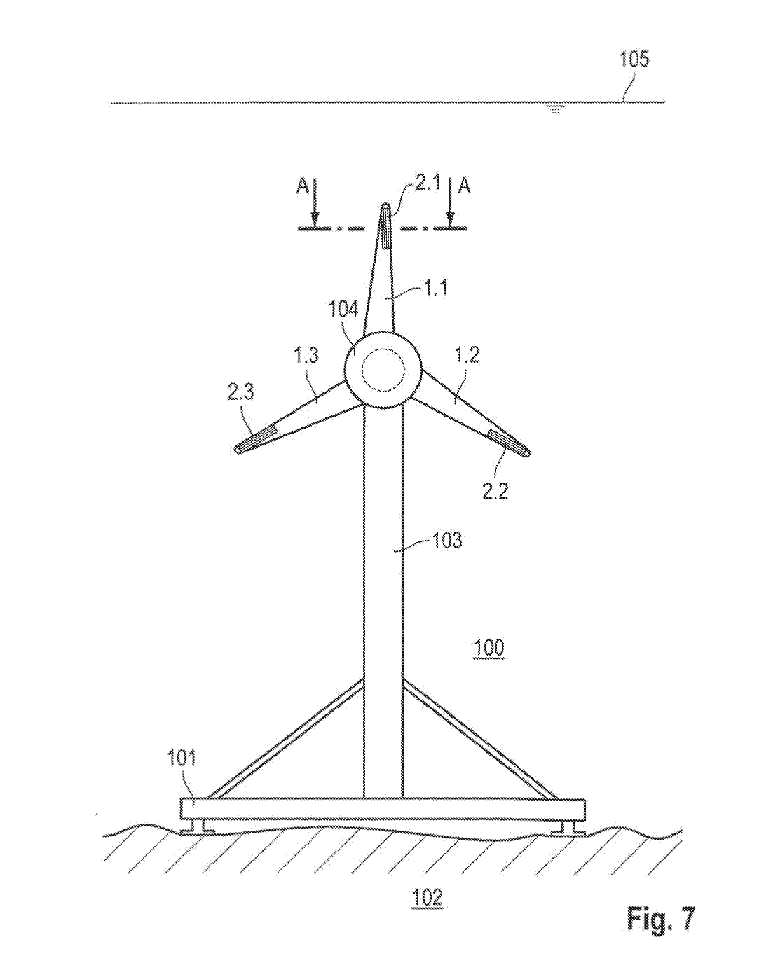

FIG. 7 shows an elevation view of a tidal power plant with a water turbine whose rotor blades contain an overload protection system according to the invention.

FIG. 7 shows schematically and in a simplified view a generic energy generation plant. A tidal power plant 100 is represented with foundations 101 resting on the water bed 102. A tower 103 is supported thereon, which carries a machine gondola with a water turbine 104 that rotates thereon and that is surrounded by free flows, wherein the rotors of the turbine are horizontal. The water turbine 104 includes three rotor blades 1.1, 1.2, 1.3 whose apices define a rotation plane.

Every rotor blade 1.1, 1.2, 1.3 contains according to the invention an overload protection system 2.1, 2.2, 2.3, which is formed in the area of the respective blade tip. The arrangement of the overload protection system 2.1, 2.2, 2.3 in the radially external part of the rotor blade 1.1, 1.2, 1.3 is in addition to the high efficiency therefore advantageous since a rotor blade 1.1, 1.2, 1.3 consists of full material, in particular in a cast or steel execution, in the relatively thin area of the blade tip so that overflow channels of the overload protection system 2.1, 2.2, 2.3 can be carried out simply as bores from a manufacturing technical viewpoint.

A configuration of the overload protection system 2.1 is represented in FIG. 1. A profile section is shown along the cutting line A-A of FIG. 7. A bidirectional hydrodynamic profile 3 facing the incoming flow, a profile designed as a doubly symmetrical profile. The chord line and the central line 4 of the hydrodynamic profile 3 coincide for the present exemplary embodiment. Moreover, an angle of attack α between the central line 4 and the rotation line is shown which illustrates the mounting position of the rotor blade 1.1, 1.2, 1.3.

The effective incoming flow v_{eff1} is assumed for the operating condition sketched in FIG. 1, an incoming flow resulting from the vectorial addition of the incoming flow velocity v₁ and the negative velocity of circulation u₁. To do so, there must be a strong incoming flow which lies above a predetermined load limit threshold. The pressure side 11 lies above the central line 4 and the suction side 10 of the hydrodynamic profile 3 above the centre line 4 for the assumed effective incoming flow v_{eff1}. Overflow channels 6.1, . . . , 6.8 create a switchable hydraulic connection between the pressure side 11 and the suction side 10.

A valve arrangement 12.1, 12.2 is used to define an open and closed condition of the overflow channels 6.1, . . . , 6.8. Said valve arrangement is realised in this present instance by a membrane 7.1, 7.2 which is stretched over the inlet or outlet openings of the overflow channels 6.1, . . . , 6.8. For this purpose, stop webs 9.1, . . . , 9.6 are provided which wedge under tension the membrane 7.1, 7.2 at notches of the hydrodynamic profile 3. This creates partial sections of the membranes 7.1, 7.2 which respectively cover two overflow channels 6.1, . . . , 6.8 in the region of the outlet for the present exemplary embodiment.

The membranes 7.1, 7.2 include a plurality of membrane openings 8.1, . . . , 8.8, which are respectively offset to the outlet openings of the associated overflow channels 6.1, . . . , 6.8, so that under normal conditions, i.e. during the operation of the plant below the load limit threshold, the overflow channels 6.1, . . . , 6.8 are sealed adequately. Accordingly, the restraint, the selection of material of the membrane 7.1, 7.2 as well as the geometry of the outlet opening match the forces exerted during operation. To do so, the membrane may consist of a fibre-reinforced material.

For the assumed incoming flow v_{eff1} the buoyancy force is applied to the membrane 7.1 on the suction side 10 of the profile, whereas the differential pressure between the suction side 10 and the pressure side 11 of the hydrodynamic profile 3 results in that the membrane 7.1 is made convex, i.e. the valve arrangement 12.1 is in the open position. The membrane 7.2 lying on the pressure side 11 for the overflow channels 6.5, . . . , 6.8 is closed in the downstream portion of the profile for the incoming flow v_{eff1}, i.e. the membrane 7.2 rests against the profile outline and the offset membrane openings 6.5, . . . , 6.8 have no overlaps with the outflow openings of the overflow channels 6.5, . . . , 6.8. The overflow channels 6.5, . . . , 6.8 may only open for a sufficient, opposite effective incoming flow V_{eff2}.

FIG. 2 shows a partial cut-out of FIG. 1 with the overflow channels 6.1, 6.2. Said channels are stretched on the suction side 10 of the hydrodynamic profile 3 with the section of the membrane 7.1 between the stop webs 9.1 and 9.2. In the operating situation represented, the valve arrangement 12.1 is in the open position. The result in this instance is that the section of the membrane 7.1 is raised with respect to the profile cover 21 in the region of the openings 18.1, 18.2 of the overflow channels 6.1, 6.2. Consequently, a flow path is created, leading to the membrane openings 8.1, 8.2 offset with respect to the outlet openings 18.1, 18.2. There is a hydraulic connection between the pressure side 11 and the suction side 10 of the hydrodynamic profile 3, a connection which causes a pressure compensation in such a way that the contribution to the power coefficient and/or thrust coefficient drops through said partial region of the hydrodynamic profile 3. The hydraulic effect of the rotor is reduced. In the case of an overload protection system 2.1, 2.2, 2.3 arranged on the rotor blade tip, we can see a water turbine whose effect corresponds to a rotor with a smaller radius, in case of overload.

The overflow channels 6.1, 6.2 sketched in FIG. 2 exhibit a diameter D which is sized so as to generate an effective pressure compensation between the pressure side 11 and the suction side 10 of the hydrodynamic profile 3. The free cross-section of the valve arrangement 12.1 is sized accordingly in the open position. Additionally, the overflow channels 6.1, 6.2 are arranged in such a way that the outflow 16 in the region of the outlet openings 18.1, 18.2 and the inflow 17 in the region of the inlet openings 19.1, 19.2 of the overflow channels 6.1, 6.2 are oriented against the suction-side profile flow 14 and the pressure-side profile flow 15. To do so, the bore angle β between the channel axis 13 of the overflow channel 6.1 and the central line 4 of the hydrodynamic profile 3 exhibit a deviation from the vertical. The resulting oblique position is oriented in such a way that the outflow 18.1 exhibits a direction component with respect to the suction-side profiled surrounding flow 14.

The upstream offset of the associated membrane opening 8.1 with respect to the outlet opening 18.1 of the flow channel 6.1 contributes to the desired outflow direction. The geometry of the inlet openings 19.1, 19.2 of the overflow channels 6.1, 6.2 is accordingly opposite the back-mounted profiled surrounding flow.

Triggering the overload protection system 2.1, 2.2, 2.3 results in a modified hydrodynamic profile for the execution with a space-consuming valve element 12.1, 12.2 in the open position, in this instance the membrane 7.1, 7.2. The profile is modified preferably in such a way that the flow is stalled faster and hence the buoyancy effect is reduced even more effectively.

Moreover, the embodiment sketched in FIG. 2 shows filters 20.1, 20.2 for covering the inlet openings 19.1, 19.2 which prevent the penetration of sediments into the overflow channels 6.1, 6.2. Additionally, the membrane openings 8.1, 8.2 can also be protected against the penetration of foreign matters. This arrangement will not be illustrated in details.

Moreover, a protection device against vegetation is preferably associated with the overflow channels 6.1, 6.2 to counteract the maritime vegetation. A protective coat can be provided to do so. Alternately, heating elements are used so as to maintain consistent overflow channels 6.1, 6.2 through regular heating cycles. For this purpose, electrical heating elements can be used, which are fed into the operating situations, when the plant generates energy which cannot be fed into the network. A further measure for maintaining the consistency of the overflow channels 6.1, 5.2 involves an excitation of vibrations. To do so, the region of the blade tips can experience resonance vibrations with the overload protection system 2.1, 2.2, 2.3 or local vibration generators, in particular for generating ultrasound, are used.

FIG. 3 shows another embodiment of the execution according to FIGS. 1 and 2 with a valve arrangement 12.1 which contains a membrane 7.1. Matching components are provided with identical reference signs in the configuration explained above. To open the valve arrangement 12.1, the membrane 7.1 must again raise with respect to the profile cover 21 in the region of the outlet openings 18.1, 18.2 of the overflow channels 6.1, 6.2. The lifting force, here necessary, against the tension force of the membrane 7.1 is triggered for the present configuration at least partially via an electrical actuator 22 in the form of a support cylinder 23 with a solenoid spool and a resetting spring element 24. The advantage of this configuration lies in that the switching effect of the valve arrangement 12.1 can be defined with accuracy. There is consequently no smooth transition between the complete closed position and the open position of the overflow channels 6.1, 6.2. Moreover, uncontrolled flutter of the membrane 7.1 due to the flow acceleration in the overflow channels 6.1, 6.2 is avoided.

Another advantage for the configuration according to FIG. 3 lies in that the membrane 7.1 can also be raised below the load limit threshold by means of the support cylinder 23. Thereby, a flushing of the overflow channels 6.1, 6.2 can take place in normal operation. Moreover, the functionality of the overload protection can be checked regularly.

The membrane 7.1, 7.2 used with an electric actuator for the execution must resist the punctual load through the support cylinder 23. The use of sheet metals with a sufficient extensibility or of fibre-armoured synthetic plates can be envisioned. Moreover, rigid elements can be used in the region of the support point of the support cylinder 23 with extensible elements to form the membrane 7.1. Moreover, in the case of a relative rigid execution of the membrane 7.1, 7.2, the membrane openings 8.1, . . . , 8.8 are preferably narrowed in the form of bores.

FIG. 4 shows an alternative embodiment whereas the overload protection system 2.1 contains a central valve arrangement 25. This is formed preferably as an electric actuator with a support cylinder 23 which switches an overflow channel 6 which extends from a pressure-side collection chamber 26 to a suction-side collection chamber 27. Said collection chambers are respectively covered with a perforated plate 28.1, 28.2 whereas the interruptions exhibit in the perforated plates 28.1, 28.2 the aforementioned oblique position with the bore angle β.

FIG. 5 shows an additional form of embodiment of the invention with two central valve arrangements 25.1, 25.2, which bundle up the overflow channels 6.1-6.4 on the one hand and 6.5-6.8 on the other. The central valve arrangements 25.1, 25.2 include control slide valves 29.1, 29.2 which extend substantially in direction of the longitudinal axis of the rotor blade 1. In this instance, it is a vertical to the paper plane. The function of the control slide valve is sketched in FIG. 2 schematically simplified. We can see a control slide valve 29 which is in the axial direction substantially parallel to the longitudinal axis of the rotor blade 1. Accordingly, centrifugal forces F act upon the control slide valve 29 during the rotation of the water turbine, forces acting against an elastic resetting element 30. As of a set rotational speed which defines the load limit threshold, the control slide valve 29 moves against the elastic resetting element 30 up to the open position of the overflow channel 6 designated by way of example. In such a case, a fluid connection between the outlet openings 18.1, 18.2 is created on the suction side 10 of the profile and the inlet openings 19.1, 19.2 of the non-visible pressure side of the hydrodynamic profile 3. In this instance, the effect of the overload protection system is triggered. Further embodiments in the context of the protected claims can be envisioned.

### LIST OF REFERENCE SIGNS

1, 1.1, 1.2, 1.3 Rotor blade
2.1, 2.2, 2.3 Overload protection system
3 Hydrodynamic profile
4 Centre line
5 Rotation plane
6, 6.1, . . . , 6.8 Overflow channel
7.1, 7.2 Membrane
8.1, . . . , 8.8 Membrane opening
9.1, . . . , 9.6 Stop web
10 Suction side
11 Pressure side
12.1, 12.2 Valve arrangement
13 Channel axis
14 Suction-side profiled surrounding flow
15 Pressure-side profiled surrounding flow
16 Outflow
17 Inflow
18.1, 18.2 Outlet opening
19.1, 19.2 Inlet opening
20.1, 20.2 Filters
21 Profile cover
22 Electric actuator
23 Support cylinder
24 Solenoid spool
25, 25.1, 25.2 Central valve arrangement
26 Pressure-side collection chamber
27 Suction-side collection chamber
28.1, 28.2 Perforated sheet
29, 29.1, 29.2 Control slide valve
30 Elastic resetting element
31 Blade tip
100 Tidal power plant
101 Foundations
102 Water bed
103 Tower
104 Water turbine
105 Water surface area
u₁, u₂ Negative velocity of circulation
v₁, v₂ Incoming flow velocity
v_{eff1}, v_{eff2} Effective incoming flow velocity
α Blade attack angle
β Bore angle
D Diameter
F Centrifugal force

1. The rotor of a water turbine with a hydrodynamic profile, to which a suction side and a pressure side are associated, comprising a plurality of overflow channels, which are arranged in the hydrodynamic profile and create a hydraulic connection between the suction side and the pressure side and to which a valve arrangement is associated respectively; characterised in that the valve arrangement is closed below a preset load limit threshold for the rotor blade and is opened above the load limit threshold, whereas every overflow channel with the valve arrangement in the open position reduces the power coefficient and/or the thrust coefficient of the rotor blade with respect to the closed position.

2. The rotor according to claim 1, whereas the load limit threshold is determined by a preset rotational speed of the water turbine and/or a preset dynamic pressure on the water turbine and/or a preset differential pressure between the suction side and the pressure side of the hydrodynamic profile.

3. The rotor according to claim 1, whereas the valve arrangement contains a membrane, which is installed on the suction side and/or on the pressure side of the hydrodynamic profile and which exhibits at least one membrane opening, which is arranged offset to an inlet opening and/or an outlet opening of an overflow channel covered by the membrane.

4. The rotor according to claim 3, whereas the membrane of the valve arrangement can be lifted from the respectively associated inlet opening and/or outlet opening to open an overflow channel.

5. The rotor according to claim 3 4, whereas the membrane can be moved passively by a differential pressure between the pressure side and the suction side of the hydrodynamic profile.

6. The rotor according to claim 5, whereas a support cylinder is associated with the membrane for moving purposes.

7. The rotor according to claim 1, whereas a common valve arrangement is associated with at least two overflow channels.

8. The rotor according to claim 7, whereas the overflow channels emerge on the pressure side of the hydrodynamic profile into a pressure-side collection chamber and on the suction side of the hydrodynamic profile in a suction-side collection chamber and whereas a hydraulic connection is provided via a central valve arrangement between the pressure-side collection chamber and the suction-side collection chamber.

9. The rotor according to claim 1, whereas the valve arrangement contains a control slide valve.

10. The rotor according to claim 9, whereas the control slide valve can be moved by the centrifugal force onto the rotor blade against the force effect of an elastic adjusting element.

11. The rotor according to claim 9, whereas a hydraulic moving mechanism is associated with the control slide valve, which can be pressurised by the dynamic pressure conditioned by the incoming flow.

12. The rotor according to claim 1, whereas the valve arrangement can be actuated electrically.

13. The rotor according to claim 1, whereas the hydrodynamic profile is designed as a bidirectional profile.

14. A method for operating a hydroelectric power station with a rotor according to claim 1, whereas the valve arrangement closes below the load limit threshold for a normal operation phase and the valve arrangement opens above the load limit threshold for a strong incoming flow phase.

15. The method for operating a hydroelectric power station according to claim 14, whereas the load limit threshold is determined by a preset rotational speed of the water turbine and/or a preset dynamic pressure on the water turbine and/or a preset differential pressure between the suction side and the pressure side of the hydrodynamic profile.

16. The rotor according to claim 2, whereas the valve arrangement contains a membrane, which is installed on the suction side and/or on the pressure side of the hydrodynamic profile and which exhibits at least one membrane opening, which is arranged offset to an inlet opening and/or an outlet opening of an overflow channel covered by the membrane.

17. The rotor according to claim 4, whereas the membrane can be moved passively by a differential pressure between the pressure side and the suction side of the hydrodynamic profile.

18. The rotor according to claim 4, whereas a support cylinder is associated with the membrane for moving purposes.
